(19) United States
(12) Patent Application Publication
(10) Pub. No.: US 2025/0305936 A1
(43) Pub. Date: Oct. 2, 2025

(54) METHODS FOR DETERMINING WATER CONTENT OF HYGROSCOPIC SOLVENTS

(71) Applicant: Funai Electric Co., Ltd., Osaka (JP)

(72) Inventors: Adam D. CARRITHERS, Lexington, KY (US); Bruce D. Gibson, Lexington, KY (US); Robert W. Milgate, III, Lexington, KY (US)

(73) Assignee: Funai Electric Co., Ltd., Osaka (JP)

(21) Appl. No.: 18/619,277

(22) Filed: Mar. 28, 2024

(51) Int. Cl. G01N 19/10; G01N 35/10; G01P 5/18

(52) U.S. Cl. CPC G01N 19/10; G01N 35/1016; G01P 5/18

(57) ABSTRACT

A method for determining the water content of a hygroscopic fluid. The method includes inserting an amount of hygroscopic fluid into a fluid ejection cartridge; attaching the fluid ejection cartridge to a fluid ejection device; activating the fluid ejection cartridge to dispense a predetermined number of fluid droplets from one or more nozzles of an ejection head attached to the fluid ejection cartridge onto a substrate to determine a total mass of the fluid droplets dispensed, a velocity of the dispensed fluid droplets or a combination of the total mass of the fluid droplets dispensed and the velocity of the dispensed fluid droplets; and using an information database that correlates the water content of the hygroscopic fluid to an average mass per fluid droplet dispensed and the velocity of the fluid droplets dispensed to determine the water content of the hygroscopic fluid.

### TECHNICAL FIELD

The disclosure is directed to determining the water content of hygroscopic fluids used for analytical techniques, and in particular to methods of using fluid jet ejection devices to accurately determine the water content of hygroscopic fluids.

### BACKGROUND AND SUMMARY

In the medical field, in particular, there is a need for automated sample preparation and analysis. The analysis may be colorimetric analysis or require the staining of samples to better observe the samples under a microscope. Such analysis may include drug sample analysis, blood sample analysis and the like. In the analysis of blood, for example, blood is analyzed to provide a number of different factors that are used to determine the health of an individual. When there are a large number of patients that require blood sample analysis, the procedures may be extremely time consuming. Also, there is a need for accurate preparation of the samples so that the results can be relied on. There are many other situations that require sample analysis in the medical field and in other fields that can benefit from the use of analytical instruments that provide accurate and reproduceable results, such as micro-titration of multiple samples.

In a typical medical application, hygroscopic solvents, and fluids such as dimethyl sulfoxide (DMSO) are often used in analytical instruments and in drug delivery due to its ability to solubilize both polar and nonpolar compounds. DMSO is miscible in a wide range of organic solvents, as well as water, and has a high boiling and freezing point. However, DMSO is highly hygroscopic, which is detrimental to the research for which it is used. For example, samples containing only 5 wt. % water in DMSO can negatively affect the stability of many drugs. When DMSO is used with automated analytical instruments, the amount of water in the DMSO can significantly affect accurate dispensing of test fluids to wells of a micro-well plate.

A common method used to determine the water content of DMSO is via a Karl Fischer titration (KFT) technique. KFT methods, either volumetric or coulometric, involve the generation of iodine in direct proportion to the amount of water present in the reaction. However, when analyzing DMSO, the DMSO is reduced by iodine in the Karl Fischer solvent to toxic dimethyl sulfide. The iodine thus released reacts again in the Karl Fisher solvent with the DMSO. Accordingly, due to the side reaction of DMSO with iodine, only small sample sizes can be analyzed before it is necessary to change the Karl Fisher solvent. Acoustic techniques may also be used to reproducibly measure water of hydration in microplates and storage tubes. However, the acoustic method requires good coupling between a piezo-electric transducer and the source vessel.

In all of the methods discussed above, the process for determining the water content of hygroscopic fluids is complex and/or requires the use of expensive equipment to perform the analysis. Accordingly, what is needed is an inexpensive method that is capable of quickly, conveniently, and accurately determining the water content of hygroscopic fluids used for analytical purposes.

In view of the foregoing, an embodiment of the disclosure provides a method for determining the water content of a hygroscopic fluid. The method includes inserting an amount of hygroscopic fluid into a fluid ejection cartridge; attaching the fluid ejection cartridge to a fluid ejection device; activating the fluid ejection cartridge to dispense a predetermined number of fluid droplets from one or more nozzles of an ejection head attached to the fluid ejection cartridge onto a substrate to determine a total mass of the fluid droplets dispensed, a velocity of the dispensed fluid droplets or a combination of the total mass of the fluid droplets dispensed and the velocity of the dispensed fluid droplets; and using an information database that correlates the water content of the hygroscopic fluid to an average mass per fluid droplet dispensed and the velocity of the fluid droplets dispensed to determine the water content of the hygroscopic fluid.

In another embodiment, there is provided a method for accurately dispensing a hygroscopic fluid. The method includes inserting an amount of hygroscopic fluid into a fluid ejection cartridge; attaching the fluid ejection cartridge to a fluid ejection device; activating the fluid ejection cartridge to dispense a predetermined number of fluid droplets from one or more nozzles of an ejection head attached to the fluid ejection cartridge onto a substrate to determine a total mass of the fluid droplets dispensed, a velocity of the dispensed fluid droplets or a combination of the total mass of the fluid droplets dispensed and the velocity of the dispensed fluid droplets; using an information database that correlates the water content of the hygroscopic fluid to an average mass per fluid droplet dispensed and the velocity of the fluid droplets dispensed to determine a water content of the hygroscopic fluid; and adjusting one or more firing parameters of the ejection head based on the water content of the hygroscopic fluid.

In some embodiments, the total mass of fluid droplets dispensed is divided by the total number of fluid droplets to obtain the average mass of per fluid droplet dispensed.

In some embodiments, the substrate comprises an analytical scale.

In some embodiments, the total mass of fluid droplets dispensed is determined by weighing the fluid ejection cartridge after inserting the fluid into the fluid ejection cartridge to provide a first weight, weighing the fluid ejection cartridge after dispensing the predetermined number of fluid droplets to provide a second weight, and calculating the average mass per fluid droplet dispensed from a difference in mass between the first weight and the second weight of the fluid ejection cartridge.

In some embodiments, the substrate is a laser sheet and the velocity of the dispensed fluid droplets is determined by dividing a predetermined distance between the ejection head and the laser sheet by a time it takes for the dispensed fluid droplets to cross the laser sheet, wherein the laser sheet is situated parallel to the ejection head.

In some embodiments, prior to the activating the fluid ejection cartridge to dispense a predetermined number of fluid droplets, the method further comprises activating a purging step to purge a predetermined number of droplets from the one or more nozzles of the ejection head.

In some embodiments, the total volume of fluid droplets dispensed is dependent upon the accuracy and resolution of the analytical scale and the desired level of confidence specified by the user.

In some embodiments, the fluid ejection cartridge is disposed in a controlled, low humidity atmosphere prior to inserting the hygroscopic fluid into the fluid ejection cartridge.

In some embodiments, the one or more firing parameters are selected from a pre-fire time, a nucleating time, a nucleating energy, a nucleating temperature, an ejection head voltage, and two or more of the foregoing.

An advantage of the foregoing embodiments is that the water content of a hygroscopic fluid can be determined quickly and easily using readily available lab scales and other inexpensive devices to provide an accurate water content level in the hygroscopic fluid being tested.

### BRIEF DESCRIPTION OF THE DRAWINGS

FIG. 1 is a side elevational view, not to scale, of a fluid cartridge for use in determining a water content of a hygroscopic fluid.

FIG. 2 is a schematic view, not to scale, of a fluid ejection device containing the cartridge of FIG. 1 for use in depositing fluid on an analytical scale according to an embodiment of the disclosure.

FIG. 3 is a schematic view, not to scale of, of a fluid ejection device containing the cartridge of FIG. 1 and a laser for generating a laser sheet according to another embodiment of the disclosure.

FIGS. 4-5 are graphical representations of a relationship between observed fluid dispense characteristics and a weight percent water in a hygroscopic fluid.

FIG. 6 is a graphical data of fluid droplet volume versus weight percent water in a hygroscopic fluid for an exemplary ejection head.

FIG. 7 is a graphical data fluid droplet velocity versus weight percent water in the hygroscopic fluid for the exemplary ejection head of FIG. 6.

### DETAILED DESCRIPTION OF EXEMPLARY EMBODIMENTS

According to the following disclosure, there are provided methods for accurately determining the weight percent water in a hygroscopic fluid, i.e., a fluid that tends to absorb moisture from the atmosphere when exposed to an ambient atmosphere containing a moisture content. The disclosure is particularly directed to dimethyl sulfoxide (hereinafter referred to as “DMSO”). However, the application is not limited to determining the water content of DMSO, as the disclosure may also be used to determine the water content of other fluids, including but not limited to, methanol, isopropanol, ethanol, glycerol, acetone, pyridine, tetrahydrofuran, acetonitrile, and dimethylformamide.

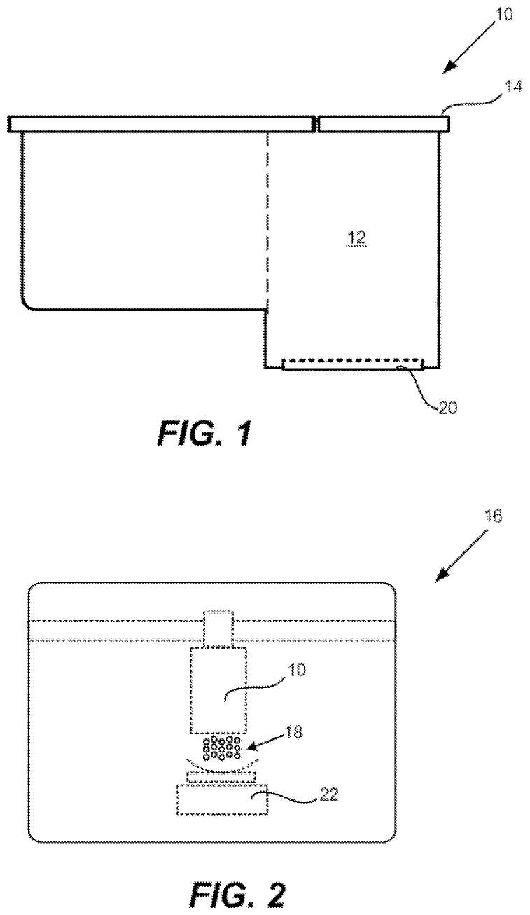

According to the disclosed methods, an amount of hygroscopic fluid is first inserted into a fluid ejection cartridge 10 (FIG. 1). The fluid ejection cartridge 10 includes a reservoir 12 therein that may be covered by a hinged cover 14 to reduce the amount of moisture the hygroscopic fluid is exposed to. The fluid ejection cartridge 10 may be disposed in a fluid ejection device 16 (FIG. 2) or attached to a fluid ejection device 16 that is configured to be activated to eject or dispense a predetermined amount of fluid droplets 18 onto a substrate from one or more nozzles of an ejection head 20 attached to the fluid ejection cartridge 10. In some embodiments, the substrate is a high accuracy analytical scale 22 that is used to determine the total mass of fluid droplets dispensed. In other embodiments, the substrate is a laser sheet, indicated by arrow 24, disposed parallel to the ejection head. The laser is generated by a laser source 26. A velocity of the dispensed fluid droplets is determined by dividing a predetermined distance D between the ejection head and the laser sheet 24 by a time it takes for the dispensed fluid droplets to cross the laser sheet 24.

Once the fluid velocity of the fluid droplets and/or the total number and total mass of fluid droplets is known, an information database is used that correlates the water content of the hygroscopic fluid with the velocity of the fluid droplets and/or the average mass per fluid droplet with the water content of the hygroscopic fluid. The information database is provided as a lookup table or equation used to determine the water content of the hygroscopic fluid from the velocity of the fluid droplets and/or the average mass per fluid droplet, and may be programmed into software in a memory of the fluid ejection device 16 or may be provided as a separate information database for reference to by a user. Since the amount of water in a hygroscopic fluid may affect the amount of fluid dispensed, the water content of the hygroscopic fluid may be used to adjust one or more firing parameters of the ejection head based on the water content of the hygroscopic fluid. Adjustments to the one or more firing parameters may be selected from a pre-fire time, a main-fire time, a delay time between the pre-fire and main-fire times, a bulk chip temperature, an ejection head voltage, and two or more of the foregoing. Thus, the embodiments described herein provide a simple but more accurate means for dispensing the correct amount of fluid from a fluid ejection head.

According to a first method, an amount of hygroscopic fluid containing an unknown amount of water is inserted into fluid ejection cartridge. A fluid ejection head on the fluid ejection cartridge is then activated so that a predetermined number of fluid ejection nozzles are caused to dispense an amount of the hygroscopic fluid onto the high accuracy analytical scale 22 to provide a total mass of hygroscopic fluid dispensed. The number of droplets dispensed is based on a nominal drop size of the hygroscopic fluid devoid of water and is adjusted to account for the resolution of the analytical scale and an acceptable measurement error as defined by a user. A higher resolution analytical scale will require fewer droplets to be dispensed than a lower accuracy analytical scale. In some embodiments, the number of fluid droplets dispensed may range from about 10 to about 1000 droplets per nozzle. The total mass of the hygroscopic fluid is then divided by the predetermined number of fluid droplets to get an average mass per fluid droplet. An information database containing a lookup table or an equation is then used to determine the water content of the hygroscopic fluid based on the calculated average mass per fluid droplet.

In a second method, a fluid ejection cartridge is filled with a hygroscopic fluid containing an unknown amount of water. The fluid ejection cartridge is then weighed on a high accuracy analytical scale. A predetermine number of fluid droplets is then dispensed into a waste reservoir based on the nominal drop size of the hygroscopic fluid devoid of water and is adjusted to account for the resolution of the analytical scale and the acceptable measurement error as defined by a user. After dispensing the predetermined number of fluid droplets, the fluid ejection cartridge is weighed again to determine a final mass of the fluid ejection cartridge which indicates the mass of fluid dispensed from the fluid ejection cartridge. The average mass of per fluid droplet of the fluid dispensed is calculated by dividing mass of fluid dispensed by the predetermined number of fluid droplets. The information database containing the lookup table or the equation is then used to determine the water content of the hygroscopic fluid based on the calculated average mass per fluid droplet.

According to a third method, a fluid ejection cartridge is filled with a hygroscopic fluid containing an unknown amount of water and fluid is dispensed from the fluid ejection cartridge directly onto the high accuracy analytical scale 22. The analytical scale 22 is in direct electrical communication with software in the fluid ejection device to which the fluid ejection cartridge is attached and the analytical scale provides instant feedback to the software to send a termination command to the fluid ejection device to cease dispensing fluid when the mass of fluid on the analytical scale is reached within the allowable measurement error as defined by a user. Based on the number of fluid droplets dispensed up until the termination command is sent by the software, the average droplet mass can be calculated by dividing the total mass of fluid on the analytical scale by the number of fluid droplets dispensed. As in the foregoing methods described above, the information database containing the lookup table or the equation is used to determine the water content of the hygroscopic fluid based on the calculated average mass per fluid droplet. An advantage of this method is that the method is effective to prevent over-dispensing and wasting of the fluid. The fluid remaining in the fluid ejection cartridge can then be recovered by the user.

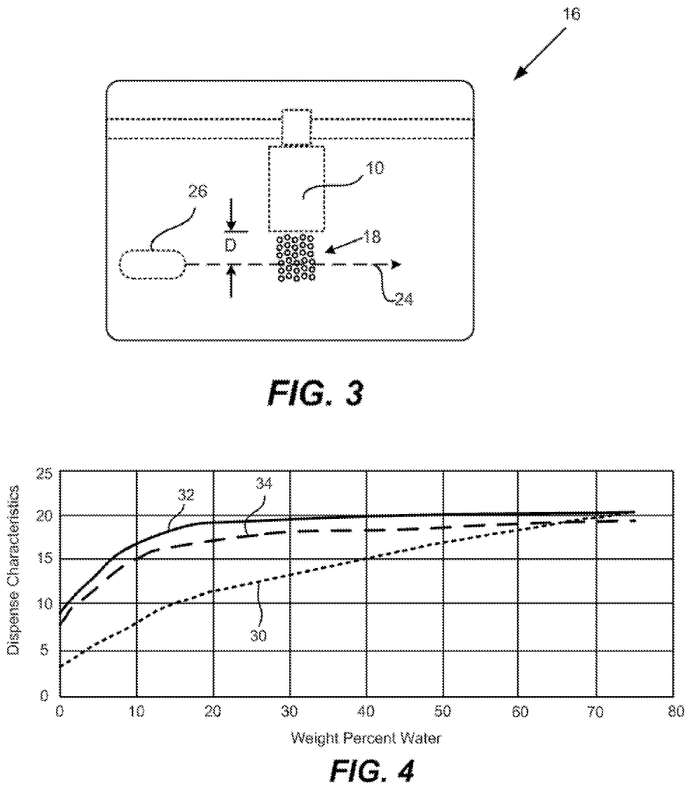

In yet another method, a fluid ejection cartridge is filled with a hygroscopic fluid containing an unknown amount of water and the fluid ejection device containing the fluid ejection cartridge is placed into an apparatus that is used to measure the droplet velocity of the dispensed fluid. For this method, a face of the fluid ejection head 10 (FIG. 3) is placed offset from a laser sheet 24 generated by a laser 26 such that the fluid droplets 18 ejected from the ejection head 10 travel a predefined distance D to pass through the laser sheet 24. The velocity of the fluid droplets is determined by software in the apparatus 16 by dividing the predefined distance D by the time it took for the fluid droplets to cross the laser sheet 24 once the fluid ejection cartridge was activated. For the purposes of this method, the number of droplets dispensed per nozzle to determine an average velocity is that number required to achieve a confidence level specified by the user. The information database containing the lookup table or the equation is then used to determine the water content of the hygroscopic fluid based on the average velocity of a fluid droplet. In some embodiments, the velocity of dispensed fluid droplets is determined on multiple droplets per nozzle for the one or more nozzles of the ejection head.

The following non-limiting example is provided to illustrate the construction of a lookup table and an equation for determining the water content of a DMSO containing fluid using one or more of the methods described above. In this example, the ejection head for ejecting fluid had the following characteristics:
Nozzle diameter: 28 um
Fluid Ejector size: 38 um×38 um
Nozzle plate thickness: 14 um
Fluid Flow layer thickness: 17 um
Fluid Ejector drive voltage: 11V.

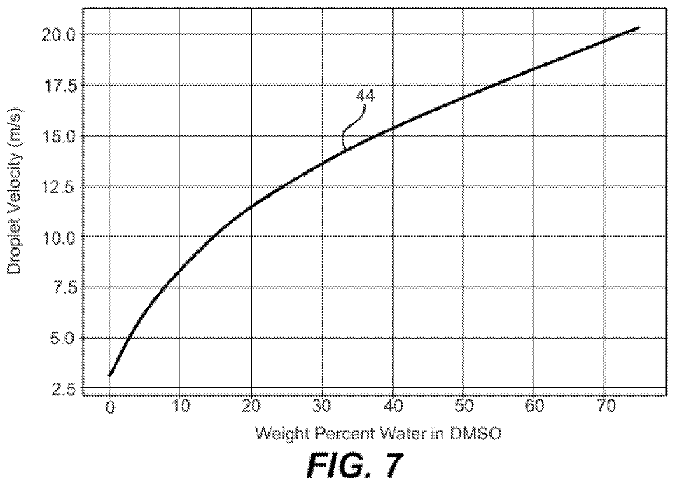

A representative look-up table for the water content of DMSO based on the volume of fluid droplets dispensed in picoliters (pL) and/or the droplet velocity in meters per second (m/s) at 55° C. is provided below. The information database relates the volume of fluid droplets and/or the droplet velocity to the water content of DMSO by reference to a lookup table. A graphical representation of the data in the Table is shown in FIGS. 6 and 7 as curves 42 and 44, respectively. The relationship between the volume of fluid droplets and/or the droplet velocity and the water content of DMSO may be represented by equations rather than a lookup table as follows

$$Droplet Volume ( pL ) = 17.42 - ( 9.33 ⋆ {e}^{( - 12.93 ⋆ Water Fraction )} ) + ( 2.41 * Water Fraction )$$

$$And$$

$$Droplet Velocity ( m / s ) = 9.95 - ( 6.92 ⋆ {e}^{( - 8.31 ⋆ Water Fraction )} ) + ( 13.9 ⋆ Water Fraction ) .$$

In the above equations, the “water fraction” is converted to weight percent water by multiplying by 100. It is to be understood that a different ejection head than the one use for the foregoing example may provide different results.

TABLE

| Weight % Water | Droplet Volume (pL) | Droplet Velocity (m/s) |
|---|---|---|
| 0.2% | 8.3 | 3.4 |
| 1.0% | 9.5 | 3.5 |
| 2.0% | 10.2 | 4.6 |
| 4.0% | 11.6 | 5.4 |
| 8.0% | 14.4 | 7.0 |
| 12.0% | 15.8 | 9.4 |
| 16.1% | 16.8 | 10.6 |
| 20.2% | 17.2 | 11.6 |
| 29.8% | 18.0 | 13.4 |
| 39.9% | 18.1 | 15.1 |
| 49.9% | 18.6 | 16.8 |
| 74.9% | 19.3 | 20.4 |

The mass of the droplets in nanograms (ng) can be determined from the volume of the fluid and the specific gravity of the fluid. Interpolations can be used to find the weight percent water in the DMSO for volume and velocity data that falls between ranges in the above table.

For all of the foregoing methods, it is important to begin the mass, velocity, and/or volume measurements once the fluid ejection cartridge has reached a steady state condition. Accordingly, a predetermined number of droplets of fluid may be ejected (i.e., purged) from the fluid ejection cartridge and disposed of before activating the fluid ejection cartridge for each of the methods described above for determining the water content of a hygroscopic fluid. The number of droplets per nozzle to be purged is that amount required to achieve a confidence level specified by the user.

Accordingly, the volume of fluid necessary to be purged is dependent upon several parameters such as ambient conditions, fluid characteristics, and the design of the ejection head. The volume of fluid to be purged may be a predetermined amount, or the characteristics of the dispensed droplets may be monitored until a steady state condition is found. It is preferred that the smallest amount of fluid necessary be purged from the ejection head to prevent waste.

For a given ejection head design and hygroscopic fluid, the droplet size is a function of the concentration of water in the fluid. Since the dispensed fluid droplets carry heat away from the ejection head, the ejection head temperature rise or rate of change of temperature during fluid dispensing is a function of the droplet size and the fluid heat capacity. This provides yet another method for determining the water concentration of a hydroscopic fluid. A fluid ejection cartridge is filled with a hygroscopic fluid containing an unknown amount of water. The fluid ejection cartridge is activated to dispense fluid therefrom and the temperature of the fluid ejection head is monitored before and during droplet ejection from nozzles of the ejection head to provide a temperature rise or temperature rise profile of the ejection head which can then be used in a lookup table or equation to determine the water content of the hygroscopic fluid. The information database relates the temperature rise or temperature rise profile of the ejection head to the water content of the hygroscopic fluid by reference to a lookup table or equation.

It is known that natural process variations during manufacturing of the fluid ejection cartridge can result in variation of the delivered droplet mass and velocity. For each method described above, a standardization process may be included when using a cartridge having at least two fluid reservoirs. For instance, a first fluid reservoir may be filled with a standard jetting fluid which has been well characterized, and a second reservoir is filled with the hygroscopic fluid to be characterized. When the fluid ejection cartridge is placed into the testing apparatus described above, the standard fluid is tested first to determine the performance of the fluid ejection cartridge. Then the results from dispensing the hygroscopic fluid can be fine-tuned based on the fluid ejection cartridge dispensing characteristics, thereby increasing the accuracy of the water content determination.

It is known that the homogeneity of performance of a fluid ejection head is greater within the ejection head than across a set of fluid ejection heads; therefore, the preferred embodiment would have at least two separate sets of fluid ejectors on a single fluid ejection head in fluid-flow communication with at least two separate fluid reservoirs. One set of fluid ejectors is used for the standard fluid and one set of fluid ejectors is used for the unknown test fluid, where the performance of the of each set of ejectors is highly correlated to one another. It is, of course, possible to correlate the performance of two separate ejection heads rather than a single ejection head, which would provide an alternative embodiment.

Since the fluid ejection cartridge has a limited fluid capacity, it is necessary to limit the number of droplets dispensed by any of the foregoing methods. While number of fluid droplets dispensed in each of the methods described above is dictated by the allowable measurement error, a hard limit to the number of fluid droplets dispensed must be used so that the fluid ejection cartridge is not activated in the absence of fluid to be dispensed. It is prudent to select the maximum number of fluid droplets to be dispensed to be equivalent to the number of fluid droplets possible with the largest possible droplet size plus some predefined excess number of fluid droplets. This ensures that the fluid ejection cartridge will not run out of fluid during testing.

A standard fluid ejection cartridge may be used as described in the methods above to determine the water content of the hygroscopic fluid if the mass and velocity responses of the fluid ejection cartridge are known or have been previously characterized. However, a specialized fluid ejection cartridge may also improve the accuracy of the measurement.

As noted, a hygroscopic fluid tends to absorb moisture from the ambient atmosphere to which it is exposed. It is therefore advisable to keep the samples of hygroscopic fluid sealed to reduce water uptake from the environment. In one embodiment, the fluid ejection cartridge contains two reservoirs, a first reservoir for a standard fluid, and a second reservoir for a hygroscopic fluid having an unknown water content. The fluid ejection cartridge may be provided pre-filled with a standard fluid or the fluid ejection cartridge may be filled by the user upon use. The fluid ejection cartridge contains a first fill port for filling the first fluid reservoir and a second fill port for filling the second fluid reservoir. A septum may be used seal each of the first and second fill ports so that the fluid samples can be filled using a hypodermic needle and immediately seal upon removal of said needle. Filling through the septum will ensure the least amount of exposure of the hygroscopic fluid to the environment.

If a fluid ejection cartridge comes pre-filled with a standard fluid, it may be necessary to include a backpressure device such as foam, felt, or bladder to prevent the fluid ejection cartridge from drooling out fluid during shipping. The reservoir containing the hygroscopic fluid may optionally be left free of a backpressure device.

It is also known that water or moisture may enter a standard fluid ejection cartridge through the nozzle holes of the ejection head, creating a heavily water-concentrated volume of hygroscopic fluid in the most critical regions of the fluid ejection head. To minimize water or moisture uptake through the nozzles, the fluid ejection cartridge may include a cover over the ejection head. The cover may either be removed manually by the user prior to inserting the fluid ejection cartridge into the test apparatus, or the cover may be automatically removed/retracted by the test apparatus. In an exemplary embodiment, the fluid ejection cartridge may have a spring-loaded cover over the ejection head which is automatically retracted upon insertion of the fluid ejection cartridge into the testing apparatus. Upon removal from the apparatus, the cover automatically extends back into place over the ejection head thereby minimizing water uptake through the nozzles. The ejection head cover is especially useful in the method described above wherein a user weighs the fluid ejection cartridge instead of the volume of fluid dispensed.

In a self-contained testing apparatus, it is further possible to limit the amount of water uptake by the hygroscopic fluid by introducing dry gases into a test chamber containing the apparatus and fluid ejection cartridge. For instance, argon or nitrogen may be used to displace moist air from the test chamber, thereby reducing the water uptake into the fluid ejection cartridge or fluid sample during testing. In this instance, it may be possible to recover the hygroscopic fluid for further use, since the methods of measurement described above are nondestructive, and the hygroscopic fluid will not have increased in water content.

The fluid ejection cartridges are anticipated to be single use devices, due to the corrosive nature of some of the hygroscopic fluids. The sensitivity of the measurement can be tuned by altering the firing conditions.

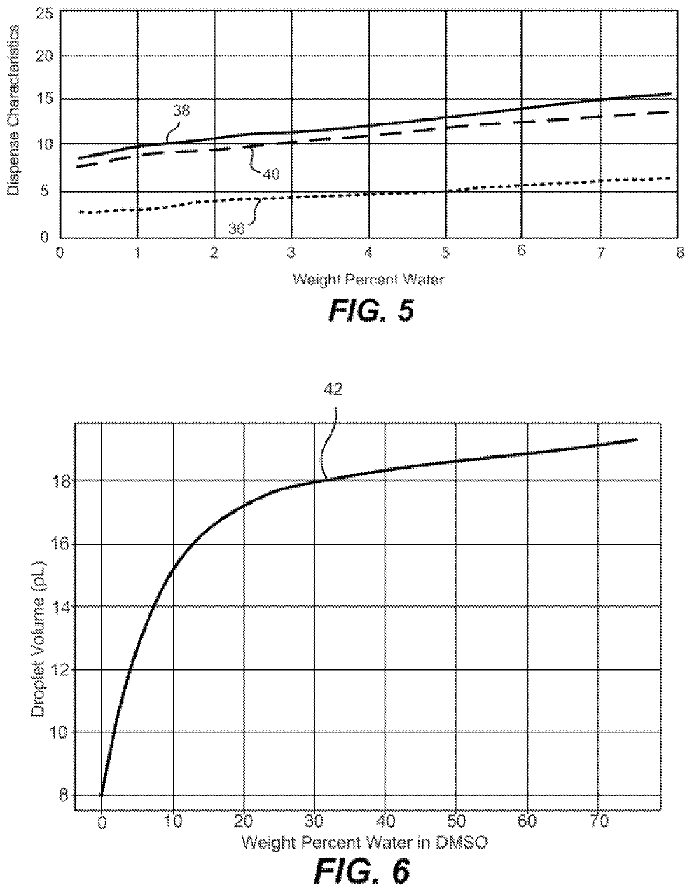

To further illustrate the foregoing methods, a fluid ejection cartridge designed to eject DMSO and water-based fluids into wells of a micro-well plate was used to determine the water content of a DMSO fluid based on the dispensing characteristics of the fluid ejection cartridge. The dispensing characteristics for the fluid ejection cartridge were determined by the configuration of nozzles and the activation frequency of the nozzles on the ejection head. FIGS. 4 and 5 illustrate certain dispense characteristics of the fluid ejection cartridge versus the water content of the DMSO solution. In the figures, the droplet mass was determined using an analytical scale and the velocity was determined using an optical inspection apparatus. For the chosen ejector design and firing parameters, line 30 in FIG. 4 indicates the velocity of a fluid droplet in meters per second versus the weight percent of water in the DMSO. Line 32 indicates a mass of the fluid droplet in nanograms versus the weight percent of water in DMSO. Line 34 indicates the volume of a fluid droplet in picoliters versus the weight percent water in DMSO. It is evident from FIG. 4 that the water content in the DMSO can significantly alter the volume, mass, and velocity of fluid delivered to a substrate. As shown in FIG. 5, for the fluid ejection cartridge design described above, the fluid droplet velocity (line 36), the droplet mass (line 38) and droplet volume (line 40) change in an approximately linear fashion with increasing water content up to about 8 wt. % water in the DMSO.

For a given ejector design and fluid, the optimal firing parameters for dispensing may differ from the optimal firing parameters for sensitivity in water concentration measurements. When there is an intent to measure the water content of DMSO, a different set of firing conditions may be used to increase the sensitivity of droplet size and/or velocity variation to fluid water content. Accordingly, water concentration profiles in hygroscopic fluids can be created for multiple firing conditions, and a user may select a particular profile based on assumed water concentration, seeding the analysis to provide more sensitivity to the method used to determine water content.

It is noted that, as used in this specification and the appended claims, the singular forms “a,” “an,” and “the,” include plural referents unless expressly and unequivocally limited to one referent. As used herein, the term “include” and its grammatical variants are intended to be non-limiting, such that recitation of items in a list is not to the exclusion of other like items that can be substituted or added to the listed items

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

While particular embodiments have been described, alternatives, modifications, variations, improvements, and substantial equivalents that are or can be presently unforeseen can arise to applicants or others skilled in the art. Accordingly, the appended claims as filed and as they can be amended are intended to embrace all such alternatives, modifications variations, improvements, and substantial equivalents.

What is claimed is:

1. A method for determining the water content of a hygroscopic fluid, comprising:
inserting an amount of hygroscopic fluid into a fluid ejection cartridge;
attaching the fluid ejection cartridge to a fluid ejection device;
activating the fluid ejection cartridge to dispense a predetermined number of fluid droplets from one or more nozzles of an ejection head attached to the fluid ejection cartridge onto a substrate to determine a total mass of the fluid droplets dispensed, a velocity of the dispensed fluid droplets or a combination of the total mass of the fluid droplets dispensed and the velocity of the dispensed fluid droplets; and
using an information database in software of the fluid ejection device that correlates the water content of the hygroscopic fluid to an average mass per fluid droplet dispensed or the velocity of the fluid droplets dispensed to determine the water content of the hygroscopic fluid.

2. The method of claim 1, wherein the total mass of fluid droplets dispensed is divided by the total number of fluid droplets to obtain the average mass of per fluid droplet dispensed.

3. The method of claim 1, wherein the substrate comprises an analytical scale.

4. The method of claim 3, wherein the analytical scale provides instant feedback to the software to send a termination command to the fluid ejection device to cease dispensing fluid when the total mass of the fluid droplets dispensed onto the analytical scale is reached within an allowable measurement error as defined by a user.

5. The method of claim 1, wherein the total mass of fluid droplets dispensed is determined by weighing the fluid ejection cartridge after inserting the fluid into the fluid ejection cartridge, weighing the fluid ejection cartridge after dispensing the predetermined number of fluid droplets, and calculating a difference in mass of the fluid ejection cartridge.

6. The method of claim 1, wherein the substrate is a laser sheet and the velocity of the dispensed fluid droplets is determined by dividing a predetermined distance between the ejection head and the laser sheet by a time it takes for the dispensed fluid droplets to cross the laser sheet.

7. The method of claim 1, wherein prior to the activating the fluid ejection cartridge to dispense a predetermined number of fluid droplets, the method further comprises activating a purging step to purge a predetermined number of droplets from the one or more nozzles of the ejection head.

8. The method of claim 1, wherein prior to the activating step, the method further comprises activating a purging step wherein the droplets are dispensed from the one or more nozzles of the ejection head until a steady state condition of the droplets is realized by the software of the fluid ejection device.

9. The method of claim 1, wherein the predetermined number of droplets dispensed per nozzle to determine an average velocity of the dispensed fluid droplets is a function of a desired confidence level of a water concentration measurement as specified by a user.

10. The method of claim 3, wherein the total mass of fluid droplets dispensed is a function of a desired confidence level of a water concentration measurement as specified by a user and the accuracy and resolution of the analytical scale.

11. The method of claim 1, wherein the fluid ejection cartridge is disposed in a controlled, low humidity atmosphere prior to inserting the hygroscopic fluid into the fluid ejection cartridge.

12. A method for accurately dispensing a hygroscopic fluid, comprising:
inserting an amount of hygroscopic fluid into a fluid ejection cartridge;
attaching the fluid ejection cartridge to a fluid ejection device;
activating the fluid ejection cartridge to dispense a predetermined number of fluid droplets from one or more nozzles of an ejection head attached to the fluid ejection cartridge onto a substrate to determine a total mass of the fluid droplets dispensed, a velocity of the dispensed fluid droplets or a combination of the total mass of the fluid droplets dispensed and the velocity of the dispensed fluid droplets;
using an information database in software in the fluid ejection device that correlates the water content of the hygroscopic fluid to an average mass per fluid droplet dispensed or the velocity of the fluid droplets dispensed to determine a water content of the hygroscopic fluid; and
adjusting one or more firing parameters of the ejection head based on the water content of the hygroscopic fluid.

13. The method of claim 12, wherein the one or more firing parameters are selected from the group consisting of a pre-fire time, a main-fire time, a delay time between the pre-fire time and main-fire time, a bulk chip temperature, an ejection head voltage, and two or more of the foregoing.

14. The method of claim 12, wherein the total mass of fluid droplets dispensed is divided by the total number of fluid droplets to obtain the average mass of per fluid droplet dispensed.

15. The method of claim 12, wherein the substrate is a laser sheet and the velocity of the dispensed fluid droplets is determined by dividing a predetermined distance between the ejection head and the laser sheet by a time it takes for the dispensed fluid droplets to cross the laser sheet.

16. A method for determining a water content of a hygroscopic fluid, comprising:
inserting an amount of hygroscopic fluid into a fluid ejection cartridge;
attaching the fluid ejection cartridge to a fluid ejection device;
activating the fluid ejection cartridge to dispense a predetermined number of fluid droplets from one or more nozzles of an ejection head attached to the fluid ejection cartridge while monitoring a time-temperature profile of the ejection head; and
using an information database in a software of the fluid ejection device that correlates the time-temperature profile of the ejection head to the water content of the hygroscopic fluid to determine the water content of the hygroscopic fluid.

17. The method of claim 16 wherein one or more firing parameters of the ejection head are adjusted based on the determined water content of the hygroscopic fluid.
